(19) United States
(12) Patent Application Publication
(10) Pub. No.: US 2010/0207869 A1
(43) Pub. Date: Aug. 19, 2010

(54) SECURE MAN-MACHINE INTERFACE FOR MANAGING GRAPHICAL OBJECTS ON A VIEWING SCREEN

(76) Inventors: Patrick Cazaux, Le Pian Medoc (FR); Sylvain Marchal, Bordeaux (FR)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/442,385

(22) PCT Filed: Sep. 20, 2007
(86) PCT No.: PCT/EP2007/059992

§ 371 Date: Jun. 12, 2009

(30) Foreign Application Priority Data
Sep. 22, 2006 (FR) 0608337

(51) Int. Cl. G09G 5/00

(52) U.S. Cl. 345/156

(57) ABSTRACT

The field of the invention is that of man-machine interface devices for viewing screen (1), said screen being able to display graphical objects (10) called “widgets”, said interface device making it possible to carry out the operations of navigating, selecting and activating said graphical objects (10), the device comprising at least: a computer (2) linked to the viewing screen (1), the computer generating on the screen a virtual designation element called a focus, said focus being able to be positioned on the entirety of the graphical objects (10); a keyboard (4) linked to the computer and comprising function keys: navigation keys make it possible to move the focus upwards, downwards, to the right and to the left of the screen, a so-called activation key making it possible to select or activate the graphical object designated by the focus; a so-called cancel key making it possible to deselect or deactivate the graphical object selected by the focus.

The field of the invention is that of man-machine interface devices making it possible to manage graphical objects shown on a display screen. There is a great variety of applications for these types of devices which are used in all the technical fields requiring a man-machine interface between a user and a display screen. However, the device according to the invention is more particularly designed for applications requiring a high level of protection for uses in harsh environments. In this case, the device is preferably used in the event of a failure of the other interface mechanisms.

This device applies most particularly to the aviation field where it is vital that the crew is able, in all circumstances, to use a simple and robust system for managing the display screens on its instrument panel.

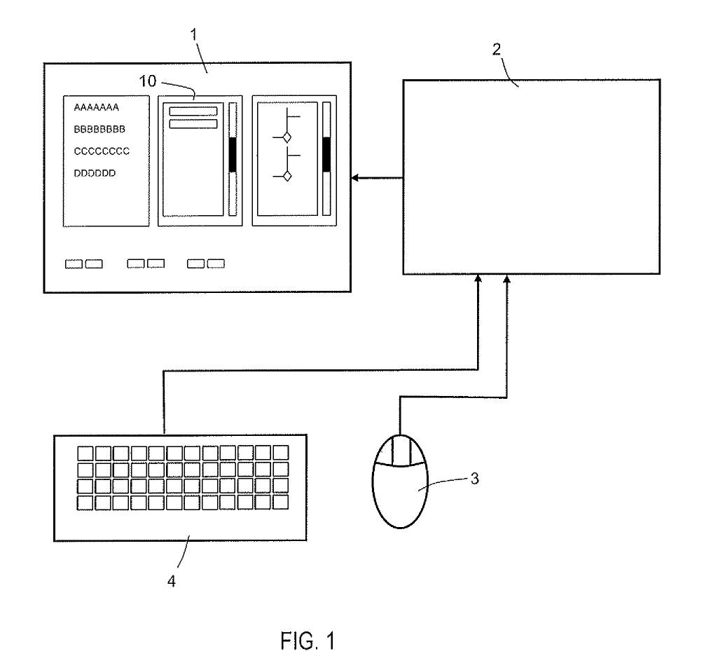

Usually, as indicated in FIG. 1, the interface devices 3 are keyboards and designation pointers more commonly known as a “mouse”, a “trackball” or a “touchscreen” depending on the technologies employed. These devices are connected to a calculator 2 or to a computer which converts the received information into graphical information 10 shown on a display screen 1. Everyone knows, for example, the cursor in the shape of an arrow representing the virtual position of a “mouse” on a screen. An alphanumeric keyboard 4 makes it possible to enter text on the display screen 1.

In the rest of the description, the graphical objects will be given their English name of “widgets”.

The designation pointer may comprise mechanical or electromechanical elements which are capable of failing. For certain applications, notably in aviation, it is vital that the man-machine interface can continue operating correctly despite this failure. The method according to the invention is particularly simple and robust. Its main advantages are that it requires only a few adaptations of the existing devices and that it is particularly simple and user-friendly. It may apply to a display screen or to a set of screens, the device advantageously being inserted into the interscreen navigation mechanism of the designator. In this case, the single screen is the highest level graphical object.

More precisely, the subject of the invention is a man-machine interface device for a display system comprising at least one display screen, said system being able to display graphical objects called “widgets” on at least said screen, said interface device making it possible to carry out operations of navigation, selection and activation of said graphical objects, the device comprising at least one designation pointer and a calculator connected to said pointer and to the display screen, said calculator making it possible to convert the signals originating from the pointer into commands for the graphical objects, characterized in that:

The calculator generates on the screen a virtual designation element called the focus, said focus being able to be positioned on the whole of the graphical objects;

the designation pointer is a keyboard comprising function keys:
navigation keys making it possible to move the focus up, down, to the right and to the left of the screen;
a key called the activation key making it possible to select or activate the graphical object designated by the focus;
a key called the cancellation key making it possible to deselect or to deactivate the graphical object selected by the focus.

Advantageously, the pointer comprises six keys, four navigation keys, one activation key and one cancellation key.

Advantageously, when a primary graphical object makes it possible to select other secondary graphical objects dependent on said primary graphical object, the navigation, activation and cancellation functions of the six keys are retained and also apply to the secondary graphical objects.

Advantageously, since the display system comprises several screens, each screen can be assimilated to a primary graphical object.

Advantageously, when the focus designates a graphical object, its graphical representation changes, the change of graphical representation being able to consist in a change of at least one of the colors forming this graphical object or in the appearance of a border surrounding the graphical object.

Advantageously, the graphical objects are either:
control buttons;
editing objects making it possible to enter a character string;
selection objects making it possible to select an “item” in a list;
“scroll-panel” objects displaying a viewing window on a movable page of larger dimension.

Advantageously, when the object is a “scroll-panel”, the navigation keys make it possible to move the movable page in the whole viewing window so that the device can fulfill its navigation/selection/activation role on all of the graphical objects while making them visible to the user.

The invention will be better understood and other advantages will appear on reading the following description given in a nonlimiting manner and thanks to the appended figures amongst which:

FIG. 1 represents a man-machine interface device according to the prior art;

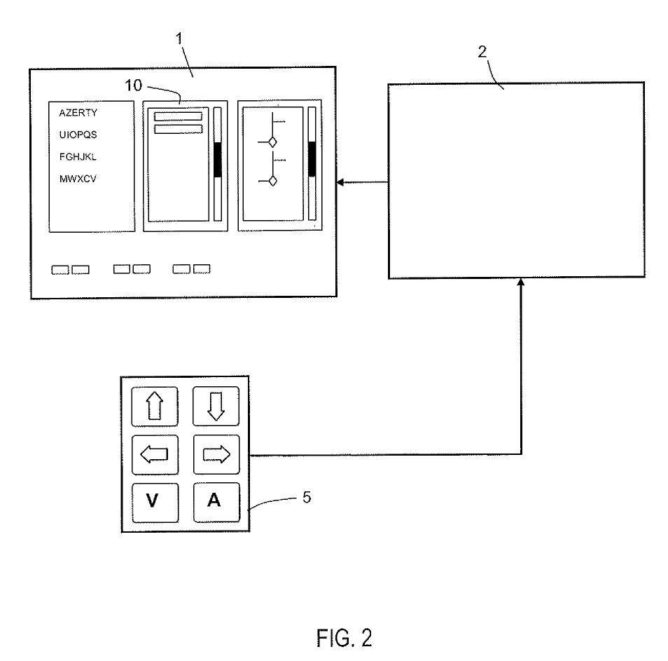

FIG. 2 represents a man-machine interface device according to the invention;

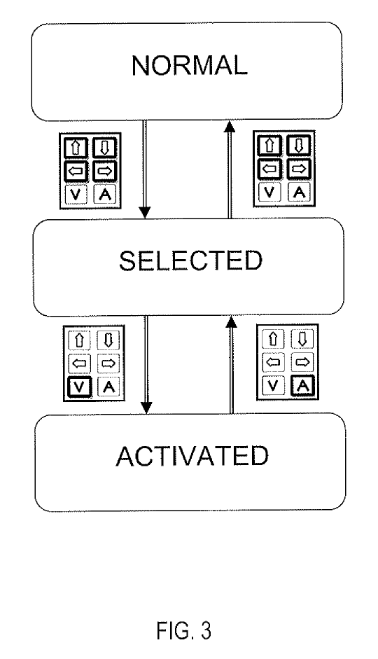

FIG. 3 represents the various states of the widgets in a device according to the invention in the case of an inter-widget navigation;

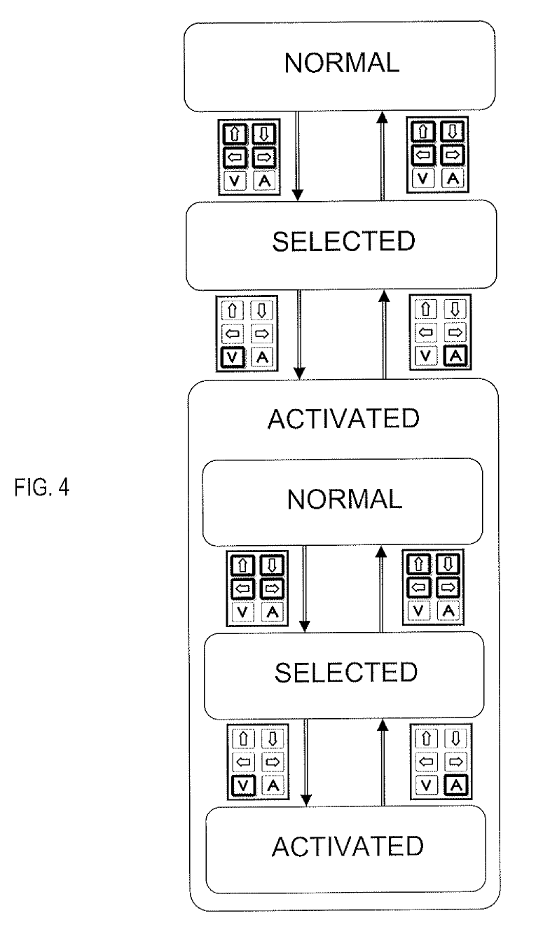

FIG. 4 represents the various states of the widgets in a device according to the invention in the case of an intra-widget navigation;

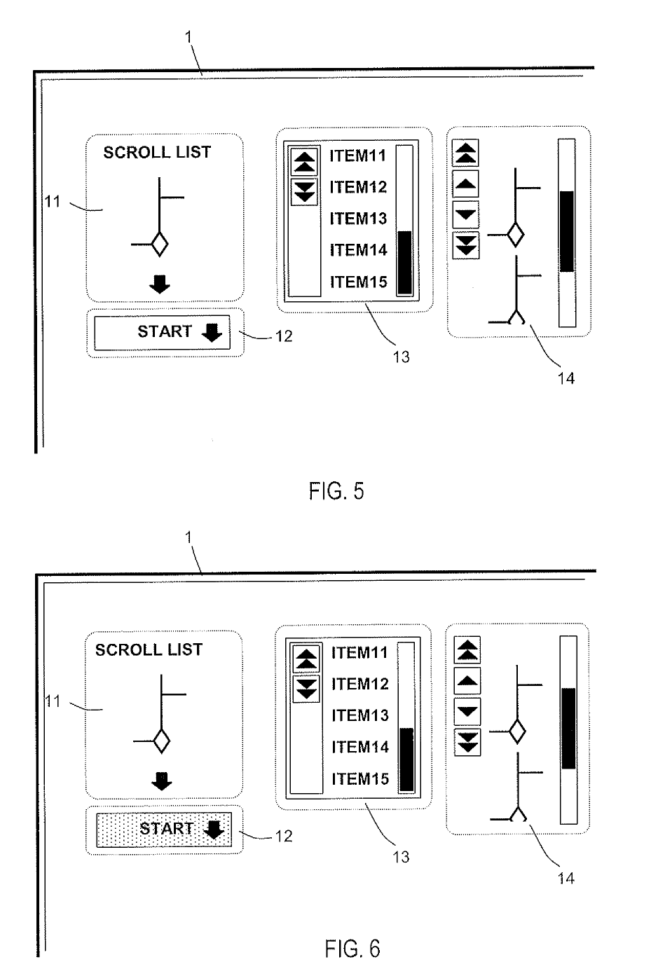

FIGS. 5 to 9 represent the same screen portion in various configurations of use of the device according to the invention.

As an example, FIG. 2 represents a device according to the invention. It comprises primarily:

A display screen 1 that is able to display graphical objects 10 called “widgets”. These graphical objects 10 are explained in detail in the rest of the description;

An electronic calculator 2 or a computer having electronic and informatic capabilities for generating the graphical objects. The calculator must generate on the screen a virtual designation element called the focus, said focus being able to be positioned on the whole of the graphical objects;

A designation pointer 5. The latter comprises six keys which are:
four navigation keys making it possible to move the focus from widget to widget up, down, to the right and to the left of the screen;
a fifth key called the activation or validation key making it possible to select or to activate the graphical object designated by the focus;
a sixth cancellation key making it possible to deselect or deactivate the graphical object selected by the focus.

For reasons of clarity, FIG. 2 comprises only one screen. Naturally, the interface device according to the invention may also apply to a display system comprising several screens. In this case, it is possible to consider each graphical screen as a higher-level graphical object. The focus is then the only one and common to all the screens.

It should be noted that the loss of the alphanumeric keyboard will advantageously be compensated for by a graphical application representing this same keyboard, in the form of a touch-control button for example, and able to be used with the aid of the device according to the invention.

In FIGS. 2, 3 and 4, the pointer is represented by an assembly of 6 keys grouped together in two columns of three keys, the navigation keys supporting an arrow, the validation key supporting a V and the cancellation key supporting an A. This arrangement is given as an example and any other arrangement fulfilling the same functions is equally possible. It is possible to envisage other arrangements of keys or to have several functions performed by the same key. For example, the cancellation function could be performed automatically after a period of absence of key commands. In FIGS. 3 and 4, the use of the keys is indicated by a heavy shaded border. This pointer is particularly simple and operates by means of elements having very high reliability.

It should be noted that the pointer according to the invention does not exclude the use of other pointers such as mice or tactile surfaces. Naturally, a conventional or graphical keyboard is necessary for entering the various text or calculation information.

The operation of the pointer is very simple. This interface is used without distinction to navigate, select and activate the various graphical objects displayed, called the inter-widget mode, and to navigate, select and activate the various graphical objects of one and the same widget, called the intra-widget mode.

Inter-widget navigation is illustrated in FIG. 3. The principle of navigation lies in the use of the virtual designation element called the focus. Each widget has three possible states which are:

the “NORMAL” state. In this state, the focus is not on the widget;

the “SELECTED” state. In this state, the focus is on the widget. The user passes from the normal state to the selected state by moving the focus by means of the navigation keys onto the widget that he desires to select. To allow the user to determine the selected object visually, when the focus is designating a graphical object, the representation of this graphical object changes, the change of graphical representation being able to consist in the change of at least one of the colors forming this graphical object or in the appearance of a border surrounding the graphical object.

the “ACTIVATED” state. The user passes to this state by pressing the validation key and leaves this state automatically, for example, at the end of a period of inactivity or by pressing the cancellation key. Depending on the function of the widget, validation may activate various functions that will be explained in detail in the rest of the description.

Certain primary widgets comprise secondary widgets. Management and navigation inside secondary widgets obey the same rules as illustrated in FIG. 4. Therefore, there will be three possible states for each secondary widget, namely:
the “NORMAL” state;
the “SELECTED” state;
the “ACTIVATED” state.

These various states are also selected by the navigation, selection and cancellation keys on the keyboard.

The graphical objects are of different types. They may be:
control buttons;
“Edit” objects making it possible to enter a character string;
“Selection” objects making it possible to select an “item” in a list;
“Scroll-panel” objects displaying a viewing window on a movable page of larger dimension.

As examples, FIGS. 5 to 9 illustrate the use of the interface according to the invention on various types of graphical objects represented on a display screen portion. In these figures, the same graphical objects are represented in different states.

The simplest graphical objects are “buttons”. Their activation allows the user to initiate an action.

They may be single-state buttons. In this case, the user initiates an action directly. This is the case with the start/stop buttons also called “pushbuttons”. In the various figures, graphic element 12 marked “START [symbol] ” represents a button of this type. They may have two states. In this case, the user initiates an action after having entered an argument, of the 0/1 type, selected/not selected or up/down. Its use is very simple. When the button is in the “SELECTED” state, one press on the validation key starts the action commanded by the button. In this case, the cancellation key has no effect.

In FIG. 6, the “START [symbol] ”button is in the “SELECTED” state indicated by a change of background color represented by dots.

The “Edit” objects allow the user to enter a character string. The entries may be:
typed. The characters are floating, integer, ASCII, etc.
masked like the indication of the date in day/month/year form or the indication of an angle in degree/minute/second, etc.
a single line or multiline etc.

In all cases, the user needs to manipulate a local cursor specific to the text zone, in order to define the place where the text typed on the keyboard is to be inserted. This movement is made naturally by means of the navigation keys.

When the window of the edit zone is smaller than the whole of the text to be displayed, the edit zone usually has horizontal or vertical scroll bars. These bars are conventionally manipulated by mouse pointers. In the case of the device according to the invention, it is preferable to disable them. To recreate the behavior of these bars, when the local cursor is in abutment to the left, right, top or bottom of the edit zone, one press on the navigation keys in the direction of the abutment is sufficient to shift the text lines and cause the first masked line to appear. For example, if the local cursor is at the bottom of the window, one press on the navigation key making it possible to navigate downward causes the line situated beneath the last line of displayed text to appear. In the rest of the text, it will be said that the navigation keys have the “scroll” function.

To validate the character strings that have been entered, it is sufficient to press on the validation key. On the other hand, one press on the cancellation key cancels the character strings that have been entered.

The “Selection” objects allow the user to select an item in an existing list. In the various figures, the graphic element 13 represents a graphical object of this type. These “widgets” may be of the following types:
“Scroll-list”: the list of items is always displayed on the screen;
“Combo-box”: the validation of a displayed item opens a window comprising all of the items;
“Popup-button”: the validation of a particular button opens a window comprising all of the items.

In all cases, before making a selection, the user needs to move a local focus onto all the items of the list in order to designate the item that he wishes to select. This navigation is carried out by means of the navigation keys.

Naturally, the display window may also be of smaller size than all of the items to be displayed as indicated in the representation 13 of the various figures where the widget displays only the items numbered 11 to 15.

In this case, the keys may also have the “scroll” function. When the designated item is the first or the last in the displayed list, one press on one of the up or down navigation keys shifts all the items and causes the masked item to appear.

When the “Selection” object is of the “Combo-box” or “Popup-Button” type, the validation key may have a double function: it validates the selected item and it closes the open window or the “popup”. The cancellation key may also have this window-closure function.

The “Scrollarea” objects also marked “scrollpanel” are graphical objects which comprise, as their name indicates, a fixed viewing window called a “viewport” on a movable page that is larger than the “viewport” and called a “sheet”. In order to be capable of viewing the whole page, the user must be able to move the visible zone of the movable page in all directions. This function is called the “scroll” function.

There are various types of “scrollarea”.

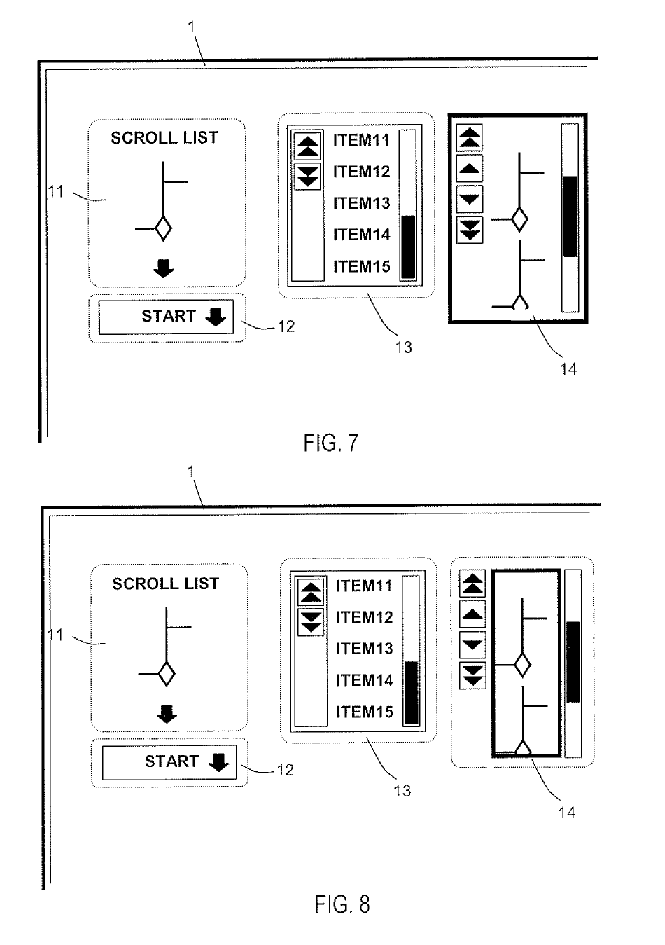

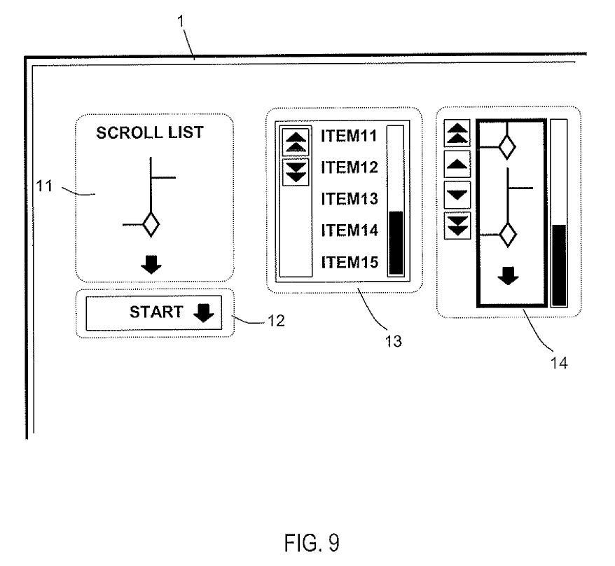

A first type, as represented by the graphic elements 11 and 14 in FIGS. 5 to 9, primarily comprises a graphical zone which may be a bitmap image or graphical primitives as indicated in the graphic elements. The management of a scroll-panel by means of the device according to the invention is very simple. By means of the navigation keys, the user moves the focus to the selected scroll-panel. As indicated in FIG. 7, it is possible to signify the presence of the focus by creating a border around the selected object. In FIG. 7, the selected object is the graphic element 14. By pressing the activation key, the user selects the graphic zone. Here again, this selection is accompanied by the generation of a border around the selected graphic zone as can be seen in the graphic element 14 of FIG. 8. To navigate in the graphic zone, the user uses the navigation keys as indicated in FIG. 9 which make it possible to move the “sheet” in the whole of the “viewport”. The edit zone usually comprises horizontal or vertical scroll bars. These bars are conventionally manipulated by mouse pointers. In the case of the device according to the invention, it is preferable to disable them.

The user conventionally returns to “selected” mode by means of the cancellation key.

A second type of “scrollarea” comprises interactive graphical objects called secondary graphical objects. The management of the secondary graphical objects inside this “scrollarea” is identical to that for the primary graphical objects. The “scroll” function may also be performed via the navigation keys. For example, if the focus is on a secondary graphical object situated on the edge of a “viewport”, one press on the navigation key which would normally bring the focus to a graphical object situated outside the “viewpoint” shifts the whole of the “sheet” so as to bring said graphical object into the “viewport”.

1. A man-machine interface device for a display system comprising at least one screen (1), said system being able to display graphical objects (10, 11, 12, 13, 14) called “widgets” on at least said screen, said interface device making it possible to carry out operations of navigation, selection and activation of said graphical objects, the device comprising at least one designation pointer (5) and a calculator (2) connected to said pointer and to the display screen, said calculator making it possible to convert the signals originating from the pointer into commands for the graphical objects, the calculator generating on the screen a virtual designation element called focus, said focus being able to be positioned on the whole of the graphical objects, the designation pointer (5) being a keyboard comprising function keys:
navigation keys making it possible to move the focus up, down, to the right and to the left of the screen,
a key called the activation key making it possible to select or activate the graphical object designated by the focus;
a key called the cancellation key making it possible to deselect or to deactivate the graphical object selected by the focus, characterized in that, when a graphical object called a primary graphical object makes it possible to select other graphical objects called secondary graphical objects dependent on said primary graphical object, the navigation, activation and cancellation functions of the keys are retained and also apply to the secondary graphical objects.

2. The man-machine interface device as claimed in claim 1, characterized in that the pointer comprises six keys, four navigation keys, one activation key and one cancellation key.

3. The man-machine interface device as claimed in claim 1, characterized in that, since the display system comprises several screens, each screen can be assimilated to a primary graphical object.

4. The man-machine interface device as claimed in claim 1, characterized in that, when the focus designates a graphical object, its graphical representation changes.

5. The man-machine interface device as claimed in claim 4, characterized in that the change of graphical representation is the change of at least one of the colors forming this graphical object.

6. The man-machine interface device as claimed in claim 4, characterized in that the change of graphical representation is the appearance of a border surrounding the graphical object.

7. The man-machine interface device as claimed in claim 1, characterized in that the graphical objects are either:
control buttons;
editing objects making it possible to enter a character string;
selection objects making it possible to select an “item” in a list;
“scroll-panel” objects displaying a viewing window on a movable page of larger dimension.

8. The man-machine interface device as claimed in claim 7, characterized in that, when the object is a “scroll-panel”, the navigation keys make it possible to move the movable page in the whole viewing window.
